(19) United States
(12) Patent Application Publication
(10) Pub. No.: US 2017/0241791 A1
(43) Pub. Date: Aug. 24, 2017

(54) Risk Maps

(71) Applicant: Allstate Insurance Company, Northbrook, IL (US)

(72) Inventors: Regina Madigan, Mountain View, CA (US); Timothy W. Gibson, Barrington, IL (US)

(21) Appl. No.: 15/052,291

(22) Filed: Feb. 24, 2016

(51) Int. Cl. G01C 21/34; G06Q 40/08

(52) U.S. Cl. CPC G01C 21/3461; G06Q 40/08

(57) ABSTRACT

A system including a computing device may receive base map information and trip request information. The base map information may include a plurality of attribute information associated with a plurality of road segments. The trip request information may include a destination to which a user plans to drive a vehicle. The computing device may determine a route for the user to travel based on the trip request information and base map information. The system might further calculate a risk score for each road segment forming the route, and generate a risk map based on the risk score and the route and cost of insurance along the route. The risk map may then be displayed to a user with alerts communicated on the map or via verbal alerts. The risk map may include markers or other objects depicting potential risks along the route the driver may face. Also, the risk map may be updated based on information collected from multiple sensors coupled to the vehicle, mobile phone or insurance database.

### BACKGROUND

Nowadays, many vehicles come equipped with global positioning system (GPS) devices that help drivers to navigate roads to various locations. Moreover, many drivers use other mobile devices (e.g., smartphones) that have GPS devices therein to help the drivers navigate roads. These GPS devices may provide location information and use maps for navigation purposes. As GPS devices have become more prevalent, the different uses for their location information have come to light. In some instances, the danger level of different routes is determined by combining location information and accident history information. Although some entities may find the danger level of certain routes useful and interesting, such information alone might not relate to the amount of risk a driver assumes traveling a particular route, or the cost to insure a driver while traveling a particular route. Therefore, there remains a desire for methods and systems that may determine the risk level of the roads drivers travel and a cost of insurance for traveling those roads.

Additionally, it is difficult to use the location information to determine the cost of insurance per a route traveled when the location information merely includes GPS coordinates. Insurance providers may find determining the cost of insurance per a route particularly important. When a driver (or insurance policy holder of the vehicle) travels one route compared to another route, the driver may be assuming more risk due to different conditions along the route they chose to travel. The insurance provider may wish to determine the cost of insurance for traveling a particular route in order to properly cover and insure a driver based on the risk they are exposed to while traveling the particular route. Currently, policyholders pay for or purchase insurance based on their driving history, individual characteristic, location, and amount of travel. There is a desire for methods and systems that facilitate a map that identifies and determines the risks along routes traveled during a trip, the amount of insurance coverage needed for the trip, and the cost of insurance based on the risks faced along the roads traveled during the trip.

### SUMMARY

The following summary is for illustrative purposes only and is not intended to limit or constrain the detailed description. The following summary merely presents various described aspects in a simplified form as a prelude to a more detailed description provided below.

Various approaches to helping users identify and mitigate risk are presented. In accordance with aspects of the disclosure, a computing system may generate, based on a vehicle traveling on a segment of road, a map for identifying and alerting a user of a potential risk. The system may receive various types of information, including but not limited to, accident information, geographic information, road characteristic information, environmental information, risk information, base map data/information, road segment data/information, road attribute (attribute) information, and vehicle information from one or more sensors, servers, and/or computing devices. The system may generate a risk map using the received information. The system may calculate a risk score, route risk score, road risk score, road segment risk score, risk object risk score, etc., and associate the risk score to a particular road segment, route, and/or risk map. Further, the system may provide alerts to a user by indicating an identification of a risk object based on the calculated risk score of the risk object. The system may provide an insurance premium based on the route traveled and the risk scores associated with the route traveled.

In other aspects of the present disclosure, a personal navigation device, mobile device, and/or personal computing device may communicate, directly or indirectly, with a server (or other device) to transmit and receive a risk score(s), a risk map(s), and/or received information. The device may receive travel route information and query the memory for associated risk scores and risk maps (e.g., base maps). The risk scores may be sent for display on the device (via the risk map) or for recording in memory. The contents of memory may also be uploaded to a system data storage device for use by a network device (e.g., server) to perform various actions. For example, an insurance company may use the information stored in the system data storage device to take various actions (e.g., determine an insurance premium, create an insurance premium, adjust an insurance premium, safety warnings, etc.).

In other aspects of the disclosure, a personal navigation device, mobile device, and/or personal computing device may access a database of risk scores to assist in identifying and indicating alternate lower-risk travel routes. A driver may select among the various travel routes presented, taking into account one or more factors such as the driver's tolerance for risk or the driver's desire to lower the cost of their insurance. These factors may be saved in memory designating the driver's preferences. Depending on the driver's selection or other road or weather conditions, the cost or other aspects of the vehicle's insurance coverage may be adjusted accordingly for either the current insurance policy period or a future insurance policy period. In some cases, the cost or other aspects of the vehicle's insurance coverage may be adjusted accordingly on a per trip basis.

Certain other aspects of the disclosure include a system including a first computing device configured to communicate with one or more devices to receive base map information, wherein the base map information may include a plurality of attribute information associated to a plurality of road segments. The system may also include a first computing device configured to receive trip request information from a user device operated by a user, and determine a route for the user to travel based on the trip request information, wherein determining the route includes using the base map information and the trip request information. The system might further include a first computing device configured to calculate a risk score for each road segment of the plurality of road segments used to generate the route, generate a risk map based on the risk score and the route and time comparisons, and provide the risk map to the user.

The details of these and other aspects of the disclosure are set forth in the accompanying drawings and descriptions below. Other features and advantages of aspects of the disclosure may be apparent from the descriptions and drawings.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures in which like numerals indicate similar elements.

FIG. 1 illustrates an example operating environment in accordance with aspects of the present disclosure.

FIG. 2 illustrates an example operating environment in accordance with aspects of the present disclosure.

FIG. 3 depicts an example of a sensor coupled to a vehicle in accordance with aspects of the present disclosure.

FIGS. 4A and 4B depict a flowchart of an example process in accordance with aspects of the present disclosure.

FIGS. 5A and 5B depict a flowchart of an example process in accordance with aspects of the present disclosure.

FIG. 6 depicts a flowchart of an example process in accordance with aspects of the present disclosure.

FIG. 7 illustrates an example interface in accordance with aspects of the present disclosure.

FIG. 8 illustrates an example interface in accordance with aspects of the present disclosure.

### DETAILED DESCRIPTION

In accordance with various aspects of the disclosure, methods, non-transitory computer-readable media, and apparatuses are disclosed for generating a risk map and alerting a driver of a vehicle about a potential risk on a road the vehicle is traveling.

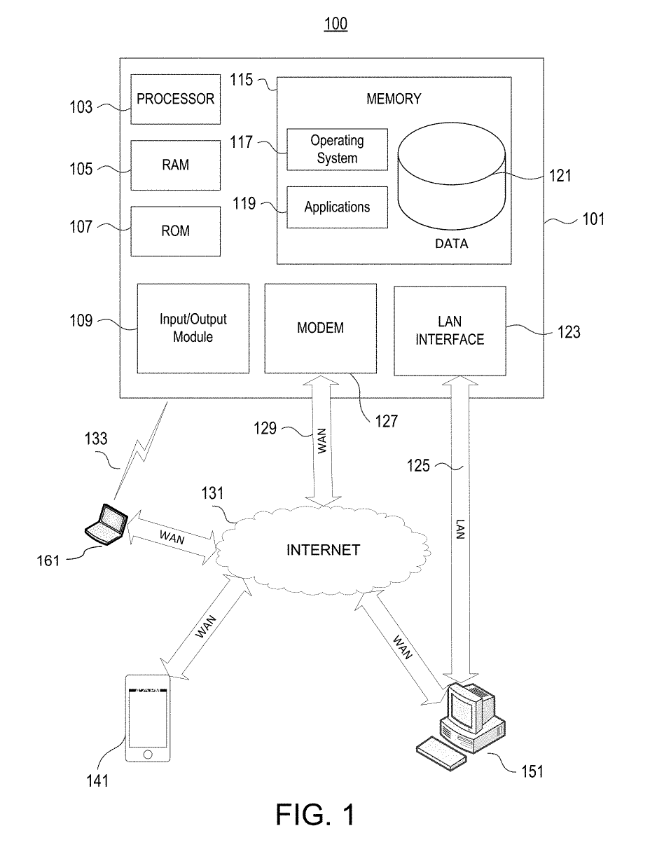

FIG. 1 illustrates an example of a suitable computing system 100 that may be used according to one or more illustrative embodiments. The computing system 100 is only one example of a suitable computing system and is not intended to suggest any limitation as to the scope of use or functionality contained in the present disclosure. The computing system 100 should not be interpreted as having any dependency or requirement relating to any one or combination of components shown in the illustrative computing system.

The present disclosure is operational with numerous other general purpose or special purpose computing systems or configurations. Examples of well-known computing systems, environments, and/or configurations that may be suitable for use with the disclosed embodiments include, but are not limited to, personal computers (PCs), server computers, hand-held or laptop devices, mobile devices, tablets, multiprocessor systems, microprocessor-based systems, set-top boxes, programmable consumer electronics, network PCs, minicomputers, mainframe computers, distributed computing environments that include any of the above systems or devices, and the like.

With reference to FIG. 1, the computing system 100 may include a computing device 101 wherein the processes discussed herein may be implemented. The computing device 101 may have a processor 103 for controlling the overall operation of the random access memory (RAM) 105, read-only memory (ROM) 107, input/output module 109, memory 115, modem 127, and local area network (LAN) interface 123. Processor 103 and its associated components may allow the computing device 101 to run a series of computer readable instructions related to receiving, storing, generating, calculating, identifying, and analyzing data to generate a risk map. Computing system 100 may also include optical scanners (not shown). Exemplary usages include scanning and converting paper documents, such as correspondence, data, and the like to digital files.

Computing device 101 may include a variety of computer-readable media. Computer-readable media may be any available media that may be accessed by computing device 101 and include both volatile and non-volatile media as well as removable and non-removable media. Computer-readable media may be implemented in any method or technology for storage of information such as computer-readable instructions, data structures, program modules, or other data. Computer-readable media include, but are not limited to, random access memory (RAM), read only memory (ROM), electronically erasable programmable read only memory (EEPROM), flash memory or other memory technology, or any other medium that can be used to store desired information that can be accessed by computing device 101. For example, computer-readable media may comprise a combination of computer storage media (including non-transitory computer-readable media) and communication media.

RAM 105 may include one or more applications representing the application data stored in RAM 105 while the computing device 101 is on and corresponding software applications (e.g., software tasks) are running on the computing device 101.

Input/output module 109 may include a sensor(s), a keypad, a touch screen, a microphone, and/or a stylus through which a user of computing device 101 may provide input, and may also include a speaker(s) for providing audio output and a video display device for providing textual, audiovisual, and/or graphical output.

Software may be stored within memory 115 and/or storage to provide instructions to processor 103 for enabling computing device 101 to perform various functions. For example, memory 115 may store software used by the computing device 101, such as an operation system 117, application program(s) 119, and an associated database 121. Also, some or all of the computer-executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices, mobile computing devices, or servers that include many or all of the elements described above about the computing device 101.

The network connections depicted in FIG. 1 include a local area network (LAN) 125 and a wide area network (WAN) 129, but may also include another type of network. When used in a LAN networking environment, computing device (e.g., in some instances a server) 101 may be connected to the LAN 125 through a network interface (e.g. LAN interface 123) or adapter in the communications module 109. When used in a WAN networking environment, the computing 101 may include a modem 127 or other means for establishing communications over the WAN 129, such as the Internet 131 or another type of computer network. It will be appreciated that the network connections shown are illustrative, and other means of establishing a communications link between the computing devices may be used. Various well-known protocols such as TCP/IP, Ethernet, FTP, HTTP and the like may be used, and the system may be operated in a client-server configuration to permit a user to retrieve a web page from a web-based server. Further, various conventional web browsers may be used to display and manipulate web pages.

Various aspects described herein may be embodied as a method, a data processing system, or as a computer-readable medium storing computer-executable instructions. For example, a computer-readable medium may store instructions to cause a processor 103 to perform steps of methods described herein. Such a processor 103 may execute computer-executable instructions stored on a computer-readable medium.

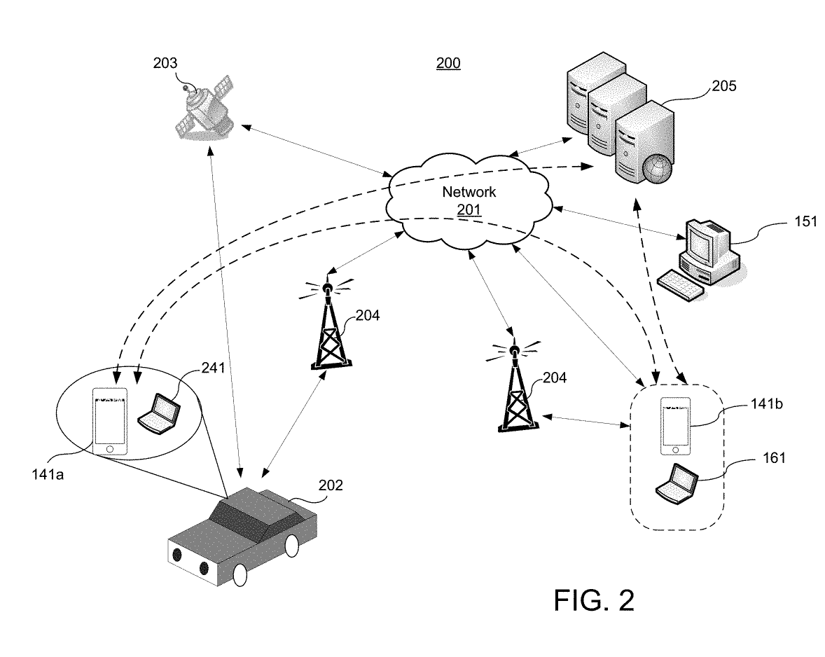

FIG. 2 illustrates an example network environment 200 for implementing methods according to the present disclosure. As shown in FIG. 2, the network environment 200 may include a network 201 configured to connect computing devices within or associated with a vehicle 202 (e.g., mobile computing device 141a or vehicle computing device 241), satellites 203, cellular network elements 204 (e.g., cell towers), one or more computing devices (e.g., 141b, 151, 161), and one or more application servers 205. Collectively, one or more of these computing devices may form a vehicle telematics management system. In some aspects, a mobile computing device 141a and a vehicle computing device 241 may be used interchangeably or may complete similar or identical functions or tasks. In describing different features of the present invention either the mobile computing device 141a or the vehicle computing device 241 may be referred to, however, it should be noted that any time that only one of these devices is described, the described device could be interchanged with the other device.

The network 201 may be any type of network, like the Internet 131 described above, and use one or more communication protocols (e.g., protocols for the Internet (IP), Bluetooth, cellular communications, satellite communications, etc.) to connect computing devices and servers within the network environment 200 so they may send and receive communications (e.g., notifications shown as dashed arrows) between each other. In particular, the network 201 may include a cellular network and its components, such as base stations. Accordingly, for example, a mobile computing device 141a (e.g., a smartphone) of a driver or passenger in a vehicle 202 may communicate, via a cellular backhaul of the network 201, with an application server 205 which in turn may communicate, via the cellular backhaul of the network 201, with computing devices or application servers (e.g., 141b, 151, 161, and 205) to provide notifications. While FIG. 2 depicts arrows pointing to the vehicle 202, it should be understood that the connections may be made with a mobile computing device 141a and/or a vehicle computing device 241 within the vehicle 202. For example, the mobile computing device 141a and/or the vehicle computing device 241 may communicate with a satellite 203 to obtain GPS coordinates or to transfer notifications to the network 201 through the satellite 203. Further, it should be understood that the mobile computing device 141a (e.g., a smartphone) may connect to the network 201 even if it is removed from the vehicle 202.

FIG. 2 illustrates only one vehicle 202. However, the vehicle telematics management system may be configured to communicate with multiple vehicles 202 simultaneously. Also, although FIG. 2 depicts the vehicle 202 as a car, the vehicle 202 may be any type of vehicle, including a motorcycle, bicycle, scooter, drone (or other automated device), truck, bus, boat, plane, helicopter, etc. FIG. 2 also illustrates an example subsystem within the network environment 200. Specifically, FIG. 2 illustrates an example arrangement of computing devices that may exist within the vehicle 202 (and other vehicles not shown). To depict these computing devices, FIG. 2 includes a view of the inside of the vehicle 202. As shown in FIG. 2, the vehicle 202 may include a mobile computing device 141a and/or a vehicle computing device 241. In some embodiments, the mobile computing device 141a and the vehicle computing device 241 may communicate with one another (e.g., via BLUETOOTH). The mobile computing device 141a may be any mobile computing device (e.g., a smartphone, tablet, etc.) that is associated with a driver, passenger, or user of the vehicle 202. The mobile computing device 141a, the vehicle computing device 241, and other devices and servers (e.g., 141b, 151, 161, and 205) may be configured in a similar manner to the computing device 101 of FIG. 1.

Further, the mobile computing device 141a and/or the vehicle computing device 241 may be configured to execute a mobile device program that provides computer-executable instructions for collecting and communicating vehicle telematics data. Also, the mobile computing device 141a and/or the vehicle computing device 241 may include a user interface for a user to provide inputs to and receive outputs from the vehicle telematics management system. Such a mobile device program may be downloaded or otherwise installed onto the mobile computing device 141a and/or the vehicle computing device 241 using known methods. Once installed onto the mobile computing device 141a and/or the vehicle computing device 241, a user may launch the mobile device program by, for example, operating buttons or a touchscreen on the mobile computing device 141a and/or the vehicle computing device 241. Additionally, or alternatively, the mobile computing device 141a and/or the vehicle computing device 241 may be configured to execute a web browser (e.g., an application for accessing and navigating the Internet) to access a webpage providing an interface for the vehicle telematics management system.

In some embodiments, a mobile computing device 141a or a vehicle computing device 241 may also be configured to collect drive data using, e.g., an accelerometer, GPS, gyroscope, etc. of the mobile computing device 141a and/or the vehicle computing device 241. Drive data may include vehicle telematics data or any other data related to events occurring during a vehicle's trip (e.g., an impact to a part of the vehicle, a deployed airbag, etc.). For example, drive data may include location information, such as GPS coordinates, indicating the geographical location of the mobile computing device 141a as well as speed and acceleration data that may be used to detect speeding, cornering and hard-braking events. The mobile computing device 141a may be further configured to evaluate the drive data and to send notifications to the vehicle telematics management system (e.g., application servers 205, computing devices 141b, 151, 161, etc.). Further, the mobile computing devices 141a may send notifications to specific computing devices or servers belonging to insurance providers interested in monitoring (or tracking) users of the mobile computing device 141a. As such, for example, an insurance provider via servers or computing devices (e.g., 151, 205, etc.) may monitor the driving behavior of a driver of a vehicle 202 based on notifications sent from the driver's mobile computing device 141a. Also, the vehicle telematics management system may allow insurance providers to monitor driving behavior of others too. The mobile computing device 141a might not necessarily be associated with (e.g., belong to) the driver, and instead, may be associated with a passenger.

Although FIG. 2 depicts just one mobile computing device 141a within the vehicle 202, the vehicle 202 may contain more or fewer mobile computing devices 141a in some cases. For example, the vehicle 202 may carry one or more passengers in addition to the driver, and each person may have one or more mobile computing devices 141a. Or, for example, the people in the vehicle 202 might not have a mobile computing device 141a or might have left their mobile computing device 141a elsewhere. In such cases, where the vehicle 202 does not contain a mobile computing device 141a, an insurance provider may monitor the vehicle 202 based on notifications received from the vehicle computing device 241 within the vehicle 202.

A mobile computing device 141a and/or a vehicle computing device 241 may communicate notifications (see dashed arrows) to one or more insurance provider computing devices. The notifications may be transmitted directly from a mobile computing device 141a or a vehicle computing device 241 to an insurance provider's computing device (e.g., 141b, 151, 161, etc.) or indirectly through, e.g., an application server 205 (e.g., a notification may be transmitted to an application server 205, which in turn may transmit a notification to the appropriate computing device 151).

A computing device operated by an insurance provider may be configured to execute an insurance device program that provides computer-executable instructions for establishing restrictions and other conditions for triggering alerts based on vehicle telematics data. The insurance device program may also provide computer-executable instructions for receiving notifications from mobile computing devices 141a and communicating parameter changes and other messages to mobile computing devices 141a. The insurance device program may also provide a user interface for an insurance provider to provide inputs to and receive outputs from the vehicle telematics management system. The insurance device program may be downloaded or otherwise installed onto a computing device operated by an insurance provider using known methods. Once installed onto the computing device, a user may launch the insurance device program by, for example, operating buttons or a touchscreen on the computing device. Additionally, or alternatively, the computing device operated by the insurance company may be configured to execute a web browser (e.g., an application for accessing and navigating the Internet) to access a web page providing an interface for the vehicle telematics management system.

Still referring to FIG. 2, as described above, the vehicle 202 may also include a vehicle computing device 241. The vehicle computing device 241 may be configured in a similar manner to the computing device 101 of FIG. 1. Further, the vehicle computing device 241 may be configured to execute the mobile device program in addition to, or instead of, the mobile computing device 141a. In some cases, the vehicle computing device 241 and the mobile computing device 141a may operate in conjunction so that the vehicle computing device 241 performs some modules of the mobile device program while the mobile computing device 141a performs other modules of the mobile device program. For example, the vehicle computing device may collect drive data (e.g., vehicle telematics data) and communicate the drive data, via a wired (e.g., USB) or wireless (e.g., BLUETOOTH) connection, to a mobile computing device 141a within the same vehicle 202 so that the mobile computing device 141a may evaluate the drive data and/or send notifications (providing evaluated drive data and/or raw drive data).

Further, the vehicle computing device 241 may be configured to connect to one or more devices (e.g., a GPS, sensors, etc.) installed on the vehicle 202 to collect the drive data. In some embodiments, the vehicle computing device 241 may be a system including multiple devices. For example, the vehicle computing device 241 may include the vehicle's on-board diagnostic (OBD) system. The vehicle computing device 241 may be configured to interface with one or more vehicle sensors (e.g., fuel gauge, tire pressure sensors, engine temperature sensors, etc.). The vehicle computing device may be configured to communicate directly or indirectly (e.g., through a mobile computing device 141a) with the vehicle telematics management system. In some embodiments, there might not be a vehicle computing device 241 installed on the vehicle 202 that is configurable to interface with the vehicle telematics management system, or the vehicle computing device 241 might not be able to communicate with a mobile computing device 141a.

An autonomously controlled vehicle 202 may be controlled by its vehicle computing device 241 and/or a remote computing device (not shown) via the network 201 or another network. The vehicle computing device 241 may employ sensors for inputting information related to a vehicle's surroundings (e.g., distance from nearby objects) and use the inputted information to control components of the vehicle 202 to drive the vehicle 202.

FIG. 2 further illustrates that the vehicle telematics management system may include one or more application servers 205. The application servers 205 may be configured to receive notifications (which may include the raw vehicle telematics data or information indicating driving events) from mobile computing devices 141a and process the notifications to determine if conditions are met (e.g., whether insurance provider restrictions have been violated). The application servers 205 may include one or more databases for associating one or more mobile computing devices 141a or one or more vehicle computing devices 241.

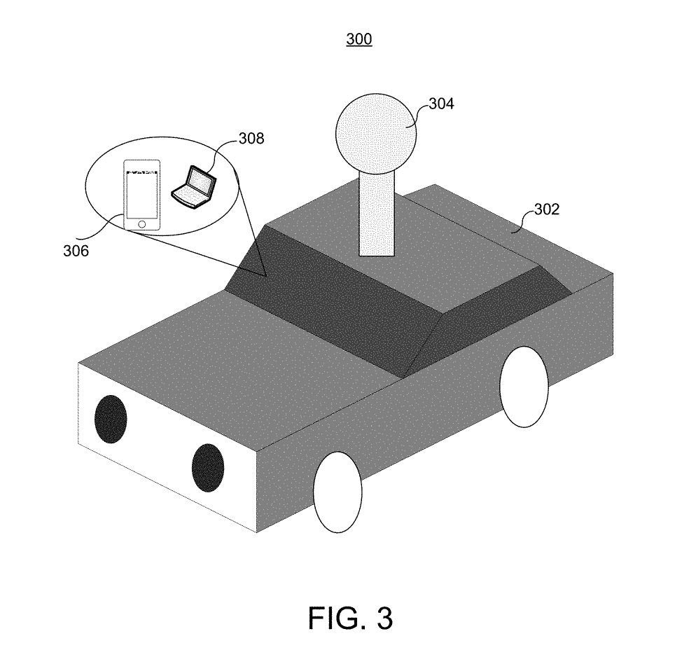

FIG. 3 illustrates an example system in which a sensor 304 may be coupled to a vehicle 302. A vehicle 302 may be similar to a vehicle 202 as shown in FIG. 2. In some examples, a plurality of sensors 304 may be used. The sensor 304 may be coupled to a vehicle 302 in the arrangement shown in FIG. 3, or in other various arrangements (not shown). In some embodiments, a sensor 304 may be located inside, outside, on the front, on the rear/back, on the top, on the bottom, and/or on each side of the vehicle 302. In some cases, the number of sensors 304 used and positioning of the sensors 304 may depend on the vehicle 302, so that sensor information for all areas surrounding the vehicle 302 may be collected.

A sensor 304 may gather or detect sensor information. The sensor information may comprise data that represents the external surroundings of the vehicle 302. In some examples, the sensor information may include data that represents the vehicle 302 so that the vehicle's shape and size may be determined from such data. The sensor 304 may comprise a light detection and ranging (LIDAR) sensor, a radar sensor, a sound navigation and ranging (SONAR) sensor, a camera or other video/image recording sensor, a light sensor, a thermal sensor, an optical sensor, an acceleration sensor, a vibration sensor, a motion sensor, a global positioning system receiver or other position sensor, a point cloud sensor (e.g., for obtaining data to generate a point cloud figure/object/image/etc.), a technology (e.g., sensing device or scanner) used to sense and detect the characteristics of the sensing device's surroundings and/or environment, and the like. In some embodiments, there may be a plurality of sensors 304 (not shown), and each sensor of the plurality may be the same type of sensor or may comprise a combination of different sensors. For example, one sensor may be a LIDAR sensor, and another sensor may be a camera. In some examples, the sensor 304 may be specially designed to combine multiple technologies (e.g., a sensor 304 may include accelerometer and LIDAR components).

The system (e.g., computing devices 306 and 308, sensor 304, etc.) may gather additional information, such as environmental information, road information (e.g., road attribute data), vehicle information, weather information, traffic information, geographic location information, accident information, etc. Environmental information may comprise data about the surroundings of the vehicle 302. In some embodiments, the environmental information may comprise road, weather, and geographic information. For example, environmental information may comprise data about the type of route the vehicle 302 is traveling along (e.g., if the route is rural, city, residential, etc.). In another example, the environmental information may include data identifying the surroundings relative to the road being traveled by the vehicle 302 (e.g., animals, businesses, schools, houses, playgrounds, parks, etc.). As another example, the environmental information may include data detailing foot traffic and other types of traffic (e.g. pedestrians, cyclists, motorcyclists, and the like).

Road information (e.g. road attribute data) may comprise data about the physical attributes of the road (e.g., slope, pitch, surface type, grade, number of lanes, traffic signals and signs and the like). In some aspects, the road information may indicate the presence of other physical attributes of the road, such as a pothole(s), a slit(s), an oil slick(s), a speed bump(s), an elevation(s) or unevenness (e.g., if one lane of road is higher than the other, which often occurs when road work is being done), etc. In some embodiments, road information may comprise the physical conditions of the road (e.g., flooded, wet, slick, icy, plowed, not plowed/snow covered, etc.). In some instances, road information may be data from a sensor that gathers and/or analyzes some, most, or all vertical changes in a road. In other examples, road information may include information about characteristics corresponding to the rules of the road or descriptions of the road: posted speed limit, construction area indicator (e.g., whether location has construction), topography type (e.g., flat, rolling hills, steep hills, etc.), road type (e.g., residential, interstate, 4-lane separated highway, city street, country road, parking lot, etc.), road feature (e.g., intersection, gentle curve, blind curve, bridge, tunnel), number of intersections, whether a roundabout is present, number of railroad crossings, whether a passing zone is present, whether a merge is present, number of lanes, width of roads/lanes, population density, condition of road (e.g., new, worn, severely damaged with sink-holes, severely damaged by erosion, gravel, dirt, paved, etc.), wildlife area, state, county, and/or municipality. In some embodiments, road information may include data about infrastructure features of the road. For example, infrastructure features may include intersections, bridges, tunnels, railroad crossings, and other roadway features.

In some aspects, road information may include a large number (e.g., 300) attributes or more for each road segment. Each road may include one or more road segments, and different roads may include a different number of road segments. Also, road segments may vary in length. In some embodiments, road segments may be determined based on the attributes. These attributes may be obtained from a database or via a sensor. In some cases, the attributes of each road segment may be geocoded to a specific road segment or a specific latitude and longitude. For example, the attributes may be things such as, but not limited to, road geometry, addresses, turn and speed restrictions, physical barriers and gates, one-way streets, restricted access and relative road heights, etc. As another example, the road attribute data may consist of information identifying that a road segment has a curvature of 6 degrees.

In some aspects, road information may consist of volume data. Volume data may be information about how many cars travel over a road segment in a given time period. Volume data may also be obtained from a database or from a sensor. In some embodiments, the volume data may include information about the number of accidents per road segment, and/or the number of accidents per road segment in a given period of time. In some aspects, road information may include the flow of traffic in both historical patterns and in real time. In some aspects, road information may include claims data. For example, the claims data may be stored and obtained from a database and include information or be based from the first notice of loss. The claim data may be geocoded to a specific latitude and longitude of a road segment and may include directionality.

In some aspects, road information may include traffic data/traffic information. For example, traffic information may be information regarding traffic flows, jams, route closures, street/road closures, lane closures, and the like. Traffic information may include traffic reports, which may be distributed in real-time, about congestion, detours, accidents, etc. In some embodiments, a risk map may receive or gather information from numerous traffic cameras along a route a vehicle is traveling to determine the quickest most time efficient route to travel to a destination. In some instances, traffic information may refer to real-time roadway speeds, which are indicative of the amount of congestion and activity on the roadway. In some aspects, the risk map may gather traffic conditions from other computing devices and/or applications, for example HERE, to get information such as actual speed on the road and other variables. The risk map may then use this obtained information to help estimate risk on the road.

Weather information may comprise data about the weather conditions relative to a vehicle's 302 location (e.g., snowing, raining, windy, sunny, dusk, dark, etc.). In some aspects, weather information may include a forecast of potential weather conditions for a road segment being traveled by vehicle 302. For example, weather information may include a storm warning, a tornado warning, a flood warning, a hurricane warning, etc. In some aspects, weather information may provide data about road segments affected by weather conditions. For example, weather information may detail which roads are flooded, icy, slick, snow-covered, plowed, or closed. As another example, the weather information may include data about glare, fog, and the like.

Vehicle information may comprise data about how the vehicle 302 is operated (e.g., driving behavior). In some embodiments, a vehicle telematics device or on-board diagnostic (OBD) system may be used to gather information about the operation of a vehicle. For example, the vehicle telematics device may gather data about the braking, accelerating, speeding, and turning of a vehicle 302. In some aspects, vehicle information may comprise accident information (which will be described later). For example, vehicle information may include data that describes incidents (e.g., vehicle accidents) and a particular location where the incident occurred (e.g., geographic coordinates associated with a road segment, intersection, etc.). In some aspects, vehicle information may include the vehicle make, vehicle model, vehicle year, and the like. In some instances, vehicle information may comprise data collected through one or more in-vehicle devices or systems such as an event data recorder (EDR), onboard diagnostic system, or global positioning satellite (GPS) device. Examples of information collected by such devices include speed at impact, brakes applied, throttle position, direction at impact, and the like. In some examples, vehicle information may also include information about the car such as lights on or off, windshield wipers off or on, blinkers used, antilock brakes engaged and user information (e.g., driver, passenger, and the like) associated with the vehicle 302.

In some aspects, user information may include data about a user's age, gender, marital status, occupation, blood alcohol level, credit score, eyesight (e.g., whether the user wears glasses and/or glasses prescription strength), height, and physical disability or impairment. In some instances, user information may include data about the user's distance from a destination, route of travel (e.g., start destination and end destination), and the like. In some embodiments, the user information may comprise data about the user's non-operation activities while operating a vehicle 302. For example, the data may comprise the user's mobile phone usage while operating the vehicle 302 (e.g., whether the user was talking on a mobile device, texting on a mobile device, searching on the internet on a mobile device, etc.), the number of occupants in the vehicle 302, the time of day the user was operating the vehicle 302, etc.

Geographic location information may comprise data about the physical location of a vehicle 302. For example, the geographic location information may comprise coordinates with the longitude and latitude of the vehicle 302, or a determination of the closest address to the actual location of the vehicle 302. In another example, the vehicle location data may comprise trip data indicating a route the vehicle 302 is traveling along. In some aspects, the geographic location information may also include information that describes the geographic boundaries, for example, of an intersection (e.g. where a vehicle 302 is located) which includes all information that is associated within a circular area defined by the coordinates of the center of the intersection and points within a specified radius of the center. In some embodiments, geographic location information may include numerous alternative routes a vehicle 302 may travel to reach a selected destination. In some aspects, any geographic location information may include any geocoded data about a road segment.

Accident information may comprise information about whether a vehicle 302 was in an accident. In some aspects, accident information may identify damaged parts of the vehicle 302 resulting from the accident. For example, accident information may detail that the front bumper, right door, and right front headlight of the vehicle 302 were damaged in an accident. In some examples, accident information may detail the cost of replacement or repair of each part damaged in an accident. In some instances, accident information may include previously described vehicle information. In some embodiments, accident information may include data about the location of the accident with respect to a road segment where the accident occurred. For example, accident information may include where the accident occurred on the road segment (e.g., which lane), the type of road the accident occurred on (e.g., highway, dirt, one-way, etc.), time of day the accident occurred (e.g., daytime, night time, rush hour, etc.), and the like. In some aspects, an accident (e.g., accident location) may be geocoded to a road segment.

Some additional examples of accident information may include loss type, applicable insurance coverage(s) (e.g., bodily injury, property damage, medical/personal injury protection, collision, comprehensive, rental reimbursement, towing), loss cost, number of distinct accidents for the road segment, time relevancy validation, cause of loss (e.g., turned left into oncoming traffic, ran through red light, rear-ended while attempting to stop, rear-ended while changing lanes, sideswiped during normal driving, sideswiped while changing lanes, accident caused by tire failure (e.g., blow-out), accident caused by other malfunction of car, rolled over, caught on fire or exploded, immersed into a body of water or liquid, unknown, etc.), impact type (e.g., collision with another automobile, collision with a cyclist, collision with a pedestrian, collision with an animal, collision with a parked car, etc.), drugs or alcohol involved, pedestrian involved, wildlife involved, type of wildlife involved, speed of vehicle 302 at time of accident, direction the vehicle 302 is traveling immediately before the accident occurred, date of accident, time of day, night/day indicator (i.e., whether it was night or day at the time of the accident), temperature at time of accident, weather conditions at time of accident (e.g., sunny, downpour rain, light rain, snow, fog, ice, sleet, hail, wind, hurricane, etc.), road conditions at time of accident (e.g., wet pavement, dry pavement, etc.), and location (e.g., geographic coordinates, closest address, zip code, etc.) of the vehicle 302 at time of accident.

In some examples, accident information may be information related to emergency vehicles. This type or form of accident information may help emergency vehicles respond more quickly to accidents. In some aspects, using this type of accident information may help emergency responders to keep drivers safe. Emergency responders may be able to prepare for various types of accidents and determine the number of emergency vehicles needed at a particular accident. Examples of accident information that may help emergency vehicles include information regarding the fastest route to an accident, information regarding road closures, information regarding the type of accident (vehicle-vehicle collision, vehicle-pedestrian collision, etc.), number of people involved in the accident, and the like.

Accident information associated with vehicle accidents may be stored in a database format and may be compiled per road segment, route, and/or risk map. One skilled in the art will understand that the term road segment may be used to describe a stretch of road between two points as well as an intersection, roundabout, bridge, tunnel, ramp, parking lot, railroad crossing, or other feature that a vehicle 302 may encounter along a route. In some aspects, accident information may be geocoded to a specific latitude and longitude.

Any or all of the previously described information may be obtained from databases (e.g., received information or downloaded information) instead of being directly obtained from sensors. One or more databases may exist in the form of servers and/or computing devices, which may contain the different forms of information previously described (e.g., road information, accident information, vehicle information, environmental information, weather information, claim information, volume data, traffic information, etc.). This previously described information may be transmitted to or downloaded by a computing device, system, or used in a method to be manipulated and utilized as described by the disclosure herein.

The various forms of information previously described may enable a computing device or system to predict which road segments are most likely to have the most accidents. In some aspects, the information may be used to determine the riskiness of a road segment. Once a risky road segment is known or identified, the road attributes may be analyzed to determine if the road attributes have any correlation to the risky nature of the road segment. If the road attributes can be correlated to a risk or risk value, then the road segment attributes may be given a riskiness factor (e.g., a risk score or a road segment risk score). For example, if a road is elevated and/or rippled, the road segment containing the elevated and/or rippled road may be given a particular risk score (e.g., a road segment risk score) of 7.5 (out of 10, where 10 indicates the highest level of risk). In some instances, modifiers or indicators may identify or mark a road segment to identify a potential risk. For example, if a road segment has a steep slope and a weather condition is present that may affect the safety conditions of the road segment, then there may be a calculation or determination to modify the risk score of the road segment, and the road segment may be marked with an indicator, modifier, identifier or the like to represent this identified risk.

The way the received information may be combined and utilized may allow an insurance provider to determine a cost of insurance per trip based on the roads a vehicle 302 travels. The received information may also allow risk-informed routes to be generated. For example, a risk-informed route may let drivers or users know of dangerous areas (e.g., dangerous road segments), and send users updates as the risk of the road segments changes in value or in risk score. In some embodiments, the received information may be used to alert users that the user may be approaching a dangerous intersection and/or road segment, give users instructions on how to deal with the intersection or road segment, or interact with an autonomous car to control the way the autonomous car may be operated while traveling the intersection or road segment. In some aspects, the received information may be provided to a municipality in order to help them identify dangerous roads or roads that may need to be repaired. Providing the received information to the government may enable the government to alter dangerous roads or install warning signs. In some embodiments, the received information may be used to analyze a series of accidents and analyze the types of drives in the accidents, and/or specific conditions that occurred during the accident, which may generate a better analysis of the risk (e.g., older drivers may have a problem with unprotected left-hand turns). In other examples, the received information may be used to provide personalized alerts for different types of users and/or drivers. For example, different alerts for older drivers, teen drivers, drivers from other states, or even not to provide personalized alerts to a person who travels a road segment repeatedly.

In some aspects, a system or method may be used to determine routes a particular user travels, and to pre-select the least risky route for the particular user to travel. In some cases, the system or method may be used to provide recommendations for a safer route to travel based on analyzing the received information and creating historical pattern data. Historical pattern data may be information of routes and road segments a user commonly takes when travelling to certain locations or destinations. For example, if a user took a different highway entrance from the entrance the user typically takes, the risk may go down, e.g., 15%. This received information and historical pattern data may also be analyzed manipulated and provided to a company operating a fleet of vehicles (e.g., company with a fleet of delivery vehicles). For example, fleet companies may receive information about which routes their drivers should take based on which routes are safer, and which routes may lower their insurance premiums.

FIG. 3 illustrates computing devices 306 and 308, which may be similar to computing device 101. Computing devices 306 and/or 308 may be used for generating a risk map based on sensor information or received/downloaded information (e.g., information stored in databases) described above. For example, the computing devices 306 and/or 308 may receive sensor information from sensor(s) 304, and generate a risk map. In another example, the computing devices 306 and/or 308 may use received information received from databases (e.g., servers 205) to develop a risk map, and generate alerts that are included with the risk map that may help to alert a driver of potential risks. A risk (e.g., potential risk) may comprise anything that may create a dangerous driving condition or increase a likelihood of a vehicle 302 getting into an accident. A risk map may comprise an image (e.g., JPEG, TIFF, BMP, etc.), a video (e.g., MPEG), a graphics display (e.g. SVG), a hologram, or other visual outputs for illustrating a road segment or route being traveled by a vehicle 302. The risk map may further include markers or other indicators of risks (e.g. risk objects). Risks (e.g., risk objects) may be any item, event, or condition that may pose a danger to a vehicle 302, while the vehicle 302 is on a trip or being operated. In various embodiments, the risk map may be a multi-dimensional (e.g., two-dimensional (2D)) illustration. Further, in some embodiments, the risk map may dynamically change over time. The changes may be in accordance with geographic data indicating the vehicle's 302 location and/or other data (e.g., speed data indicating a speed of the vehicle 302 or odometer data indicating distance the vehicle 302 traveled). In some embodiments, the risk map may be keyed or coded (e.g., certain symbols, colors, and the like that represent different risks or categorize the risk objects within the risk map).

In some embodiments, computing devices 306 and/or 308 may create different risk maps for different users. For example, one risk map may be generated for a user of a vehicle 302, while a different risk map may be generated for a different user of another vehicle. The differences in the risk maps may depend on the past driving behavior of the different users (e.g., drivers) and may take into account that different things may pose different risks to different users. Although risk maps are often described herein as being displayed to drivers of a vehicle 302, it should be understood that risk maps may be generated for and displayed to pedestrians, joggers, runners, bike riders, motorcyclists, and the like. As another example, a risk map may be generated for a commercial truck driver. Under this example, different risk objects may be highlighted on the risk map such as known clearances, hanging power lines, and the like. In some embodiments, a risk map may be created for coordinating risk inside a building. For example, a risk map may be created to help a pedestrian navigate their way through a mall or an airport. In some instances, computing devices 306 and/or 308 may generate a risk map that includes risk objects based on historical data. Historical data may comprise information about the prevalence of risk objects on a particular road segment over a given period of time. For example, a risk map may include risk objects based on where future risk may be located based on historical data or where risk is historically located on a road segment. In some aspects, computing devices 306 and/or 308 may create a risk map based on pre-determined road segment information. For example, computing devices 306 and/or 308 may receive road segment information for a segment of road that the vehicle 302 is traveling on, and use the received road segment information to generate a risk map of the road segment. In some instances, computing devices 306 and/or 308 may receive one or more risk maps from another computing device, identify which particular risk map of the one or more risk maps matches the segment of road that the vehicle 302 may be traveling on, and generate a new risk map using the identified particular risk map along with sensor information obtained by the vehicle 302. In some embodiments, computing devices 306 and/or 308 may create a risk map based on risk (e.g., risk objects). In some aspects, computing devices 306 and/or 308 may create a risk map, which provides different routes to a user to mitigate risk. For example, a generated risk map may contain different routes of travel based on the road segments a user may travel to arrive at their end destination. Under this example, each route may correlate to a different risk score based on the number and the type of risk objects located on each route.

In some aspects, the computing devices 306 and/or 308 may display a risk map to a user. In some examples, the risk map may be displayed on the exterior of the vehicle 302 (e.g., on the hood of a vehicle 302), on the interior of the vehicle 302 (e.g., on a display device, LCD screen, LED screen, plasma screen, and the like), or on the windshield of the vehicle 302 (e.g., heads-up display [HUD]). In some embodiments, a risk map may be displayed as a hologram, or on augmented reality (AR) glasses, or the like.

The computing devices 306 and/or 308 may request or receive information from other computing devices (e.g., servers and databases) and sensors. For example, the computing devices 306 and/or 308 may receive sensor information from sensor(s) 304 and/or instructions/data/information from a user device or network device (not shown). The computing devices 306 and/or 308 may receive the different types of sensor information or receive the different types of information from a network server as those previously described. For example, the computing devices 306 and/or 308 may obtain environmental information, vehicle information, weather information, and the like. In some aspects, the computing devices 306 and/or 308 may receive and use the sensor information (e.g., x-plane information, y-plane information, and z-plane information) to determine whether a vehicle 302 is moving up or down.

The computing devices 306 and/or 308 may receive and store data and/or instructions from an insurance provider (via an insurance provider's server) on how to determine what poses a risk to a driver of a vehicle 302 (e.g. identify a risk object). In some instances, the computing devices 306 and/or 308 may determine a risk value or a risk score for a potential risk (e.g., risk object). For example, the computing devices 306 and/or 308 may evaluate a risk object and assign it a risk score. As another example, the computing devices 306 and/or 308 may assign a certain risk score to a road segment that is wet from rain, and assign a lower risk score to the road segment that is not wet from rain. In some embodiments, the computing devices 306 and/or 308 may calculate the risk score for a road segment, risk object, route, risk map, or point of risk by applying actuarial techniques. In some aspects, the computing devices 306 and/or 308 may determine how to identify or present a risk object to a driver. In some aspects, the computing devices 306 and/or 308 may process insurance policy information related to the user. For example, the computing devices 306 and/or 308 may update a user's insurance information, adjust the user's insurance premium, adjust the user's insurance coverage, file or submit a claim, calculate a user's insurance premium, or complete any other insurance task or process.

The computing devices 306 and/or 308 may generate an alert on the risk map to help the user identify an upcoming and potential risk(s) on their route of travel. In some aspects, the computing devices 306 and/or 308 may determine how to display a risk object to a user via the risk map. Risk objects may be displayed differently for different users depending on, for example, user preferences set by the user or demographic information. Also, a risk object may be displayed for one user, but not for another because different events, objects, etc. may pose risks to some but not to others. For example, a narrow bridge may be a risk for a novice driver, but not for an experienced driver who has driven over a narrow bridge many times before.

In some instances, the computing devices 306 and/or 308 may generate alerts that may be provided to a user about adjustments to their insurance premium or coverages. In some embodiments, the computing devices 306 and/or 308 may generate a cost of insurance per a trip. In some aspects, the computing devices 306 and/or 308 may develop risk values or risk scores, based on the received information. For example, a risk score may be a value associated with a particular road segment that is flat, and the risk score may be increased due to rain making the road wet. Under this example, the computing devices 306 and/or 308 may assign a new risk score to the road segment and notify the user that the risk score has changed. In some examples, a risk score may relate to a risk object being displayed in the risk map and the risk score may alter the presentation of the risk object within the risk map to indicate a certain level of risk associated with the risk object. For example, if there is a pothole on the road, the risk map may display the pothole in a particular color or the pothole may be blinking on the risk map. In some embodiments, a risk object may be enhanced with an indicator which may be associated with a risk ranking system. A risk ranking system may perform a method for prioritizing or labeling the different levels of risk or potential trouble/danger associated with a risk object.

In some aspects, the indicator may be a color, an animation, a sound, a vibration, and the like for indicating the level of risk associated with a risk object. For example, a pothole may be displayed in yellow if it is a moderate risk to a vehicle 302, or displayed in red if it is a severe risk to the vehicle 302. In another example, one sound may be played for a low risk while a different sound may be played for a high risk. In some examples, if a risk object is identified as being located on the left side of the vehicle 302, then a sound may play out of the left speaker(s) of the vehicle 302. In some examples, if a risk object is identified as being located on the right side of the vehicle 302, then a sound may play out of the right speaker(s) of the vehicle 302.

The computing devices 306 and/or 308 may organize and store all the information the computing devices 306 and/or 308 generate, transmit, and receive. In some aspects, the computing devices 306 and/or 308 may store risk maps. In some instances, the computing devices 306 and/or 308 may include a database for storing risk values/risk scores associated with risk objects or road segments, or for storing risk values, risk objects, or road segments. In some embodiments, the computing devices 306 and/or 308 may store routes (e.g., route information), risk objects (e.g., risk object information), and risk maps (e.g., risk map information) from other computing devices. In some cases, this stored information may be referred to as base map information. In some aspects, the computing devices 306 and/or 308 may transmit the risk map (and any other information generated or received by the computing devices 306, 308) to one or more databases or one or more servers for storage.

The computing devices 306 and/or 308 may develop a risk map. In some aspects, the computing devices 306 and/or 308 may output or display a risk map that may comprise information about the environmental surroundings of a vehicle 302 and the risks associated with the surroundings of the vehicle 302 as the vehicle 302 travels along a road segment. For example, the risk map may include the road a vehicle 302 is traveling on, along with the characteristics of the road, e.g., the trees, the buildings, and the weather conditions of the environment encompassing the road. In some embodiments, the computing devices 306 and/or 308 may retrieve GPS data and combine the GPS data with data from other engines and systems of the computing devices 306 and/or 308 to develop a risk map. In some embodiments, the risk map that the computing devices 306 and/or 308 create, may not reflect reality (e.g., the risk map may be distorted). In some instances, the computing devices 306 and/or 308 may assemble a risk map that augments reality in order to show a visual representation of the vehicle's 308 environment.

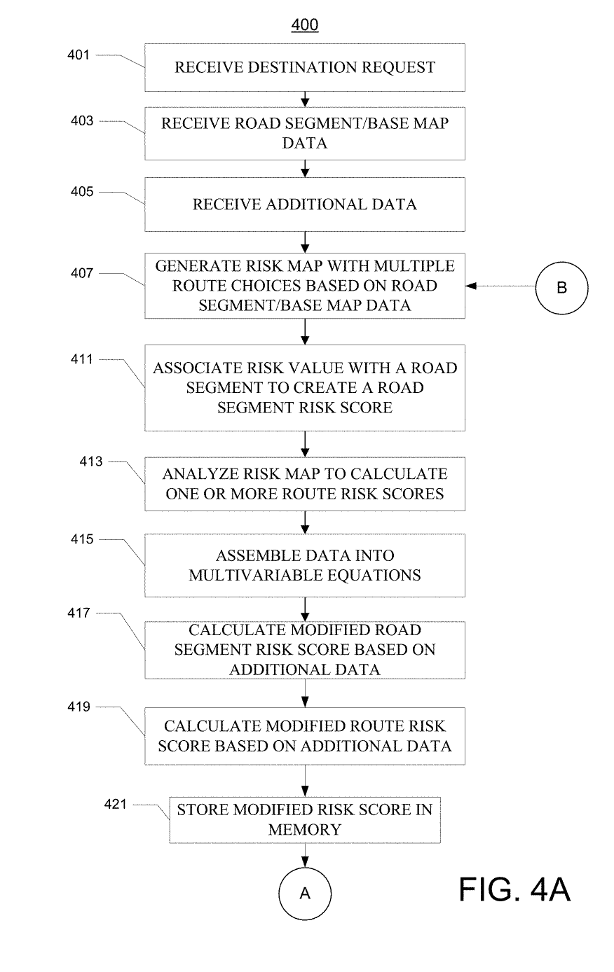

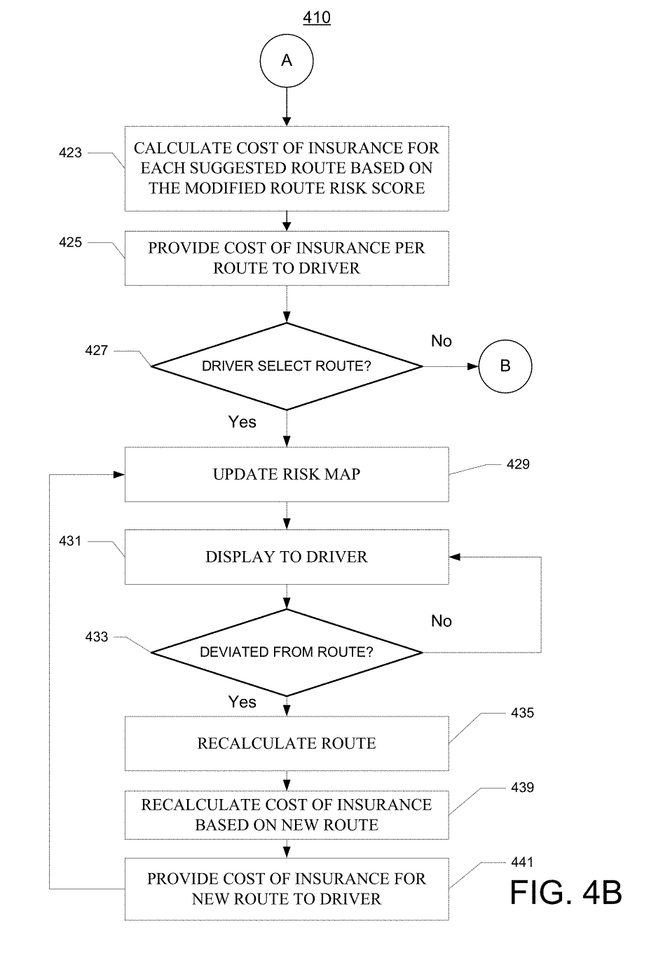

FIGS. 4A and 4B illustrate a method for generating a risk map and providing a user the cost of insurance per trip or selected route. The method may begin at step 401. At step 401, a computing device may receive a destination request. The destination request may contain information about a start and end location of a trip that a driver of the vehicle wishes to take. After receiving the destination request, the method may proceed to step 403.

At step 403, the computing device may receive road segment data or base map data (e.g., road segment information or base map information). The road segment data or base map data may be any data/information previously described. The computing device may download the road segment data or base map data from another device or database. In some embodiments, the computing device may receive the road segment data or base map data from sensors. The road segment data or base map data may be related to the destination request at step 403. The road segment data or the base map data may be of a route or a group of routes (e.g., a plurality of road segments) used to get the vehicle to the end destination of the destination request. In some embodiments, the base map data may comprise a plurality of road segments that may create a plurality of routes. In some examples, the base map data may include risk value or risk scores for each road segment (e.g., a road segment risk score) and/or a risk value or risk score for each route (e.g., a route risk score). After step 403 has completed, the method may proceed to step 405.

At step 405, the computing device may receive additional data. The additional data (additional information) may be any previously described information that may supplement the road segment data or base map data. For example, weather and/or traffic information may be additional data that may supplement the road segment data or base map data. In some aspects, the additional data may be any type of data previously described. After the computing device has received the additional data, the method may proceed to step 407.

At step 407, the computing device may generate a risk map with multiple route choices based on the road segment data and/or base map data. In some aspects, the risk map may be generated using the received additional data as well. The risk map may contain previously described alerts, modifiers, and/or identifiers for highlighting and representing risk objects. The generated risk map may include one or more routes a driver may use to travel to their end destination. The one or more routes may contain different risk objects and/or road segments from each other. The different routes may be generated based on different characteristics (e.g., using highways, side streets, rural roads, time-based, distanced based, etc.). After step 407, the method may proceed to step 411.

At step 411, the computing device may associate a stored risk value from the received road segment data and/or base map data (e.g., received information) to each road segment. Each road segment may have a pre-determined risk value assigned to it. In some aspects, the computing device may analyze the risk value for each road segment to create a road segment risk score for each road segment. In some embodiments, when a road segment does not have a risk value, the computing device may compare the road segment data for a particular road segment to road segment data for other similar road segments, and determine the appropriate risk value for the road segment based on the comparison. In some examples, the computing device may compare the road segment data for a particular road segment with a database of road segment data to determine a plurality of similar road segments, and then average the risk values of the plurality of similar road segments to determine the risk value and/or risk score for the particular road segment. In some aspects, associating the risk value may include analyzing the road segment a vehicle may travel along or through, and identifying one or more risk objects on the road segment. Once the one or more risk objects on the road segment have been identified, the computing device may analyze the characteristics of the one or more risk objects, and determine a risk value for each of the one or more risk objects. In some embodiments, once the one or more risk objects are identified, the computing system may receive a risk value for each of the one or more risk objects. After determining or receiving a risk value for the one or more risk objects, the computing device may calculate a risk score based on the number of risk objects, the characteristics of the one or more risk objects, and/or the risk value of the one or more risk objects located on the road segment. In some aspects, the computing device may have a list of pre-determined risk objects correlated to a pre-determine risk value. In some aspects, the computing device may have different groupings of risk objects (which may be categorized by the characteristics of the risk objects) correlated to pre-determined risk values. In some embodiments, a user may be able to determine, categorize, or correlate risk objects to a user selected risk score. In some embodiments, a specially configured or programmed server or computing device of an insurance provider that manages the computing system may rank, prioritize, or correlate the risk objects to a selected risk value. For example, all risk objects located on the side of the road may have a risk value of 10, while all risk objects located on the road may have a risk value of 20. In some aspects, the risk value assigned may represent the likelihood of a risk object causing an accident. For example, a pothole with a 2 ft diameter may get a higher risk value than a pot hole with a 1 ft diameter. Upon completion of step 411, the method may proceed to step 413.

At step 413, the computing device may combine the road segment risk score for each road segment to create a route risk score. Each route generated by the computing device may have its own individual route risk score, which may be created from the one or more road segments that may be combined to create that route. For example, the road segment risk scores for a route from step 411 may be combined to create a route risk score. After step 413, the method may proceed to step 415.

At step 415, the computing device may assemble the route risk scores into multivariable equations. For example, the computing device may use the data (identified at step 403) to determine a risk value of an object, or a road segment risk score or determine based on steps 411 and 413 a route risk score based on pre-determined equations. The equations may be configured for different information inputs which may affect the risk value and/or risk scores assigned to a risk object, road segment, and/or route. For example, one equation may use one of received information and sensor data while another equation may use a combination of both to determine a risk value and/or risk score. In some instances, a network device or insurance provider's server may generate and determine the multivariable equations. In some embodiments, the multivariable equations may be generated using actuarial techniques. Once the computing device assembles the received information into multivariable equations, the method may proceed to step 417.

At step 417, the computing device may calculate a modified road segment risk score based on applying the additional data. For example, the computing device may use the determined risk scores from step 411 and use the multivariable equation from step 415 to use the received additional data (e.g., geographic location information, weather information, and/or environmental information) to calculate a modified road segment risk score or scores. As another example, a risk score determined at step 411 may be adjusted. Under this example, the computing device may adjust a risk score due to a new condition (e.g. snow on the road). Due to the snow, the computing device may use the multivariable equation to determine that the previous risk score needs to be increased. Upon completion of step 417, the method may proceed to step 419.

At step 419, the computing device, based on the modified road segment risk scores generated at step 417, may generate updated/modified route risk scores. The modified route risk scores may use the modified road segment risk scores to determine new route risk score values. In some embodiments, a combination of modified road segment risk scores and road segment risk scores may be used to generate the modified route risk score. After step 419, the method may proceed to step 421.

At step 421, the computing device may store the modified road segment risk scores and modified route risk scores. In some aspects, the modified road risk scores may be correlated to mark or enhance a particular risk object, road segment, and/or risk map. The particular risk object, road segment, or route may be updated and assigned the new modified risk score. The updated risk object, road segment, or route with its updated risk score may be stored by the computing device into a database. In some aspects, the database information may be shared with other computing devices or be used to generate other risk maps with similar road segment or route characteristics. After step 421 is completed, the method may proceed to step 423.

At step 423, the computing device may calculate the cost of insurance for each suggested route based on the modified route risk score of each route. The cost of insurance may use the modified risk score to determine the potential risk objects and the likelihood of the vehicle or driver being at risk or an accident occurring. Once the cost of insurance for each route has been calculated, the risk map may proceed to step 425.

At step 425, the computing device may provide the cost of insurance per route to the driver. The computing device may transmit an alert (e.g., an email, pop-up, text message, voice message, and the like) to the driver via a mobile computing device or another computing device operated by a driver of the vehicle. Upon completion of step 425, the method may proceed to step 427.

At step 427, the driver (or user) may select a route. The computing device may determine if the driver has selected a route. The computing device may receive some form of an input at the computing device or from another device that contains the data as to whether or not a driver has selected a route. If the driver failed to select a route, the method may proceed to step 407. If it is determined that the driver did select a route, the method may proceed to step 429.

At step 429, the computing device may update the risk map with the selected route. The computing device may update the risk map by generating a new risk map, which may only contain information for displaying the selected route. After step 429, the method may proceed to step 431.

At step 431, the computing device may display the updated risk map to the driver. In some aspects, the computing device may transmit the updated risk map to the driver or to a display device in order for the risk map to be displayed. Upon completion of step 431, the method may continue to step 433.

At step 433, the computing device may determine whether or not the driver has deviated or changed from the selected route. The computing device may determine that a driver has deviated from the selected route based on the geographic coordinates of the vehicle. If the geographic coordinates do not align with coordinates of the selected route the computing device may determine the vehicle has left the selected route. In some embodiments, the computing device may receive information from a GPS device coupled to the vehicle, and using the GPS data, determine if the vehicle left the selected route. If the computing device determines the driver (more specifically the vehicle) has not deviated from the selected route, the method may return to step 431. If the computing device has determined that the driver (more specifically the vehicle) has deviated from the selected route, the method may proceed to step 435.

At step 435, the computing device may determine a new route and determine the road segments for the new route. The computing device may also determine the road segment risk scores and route risk score for the new route as previously described. Once the new route has been determined, and the new risk scores have been calculated, the method may proceed to step 439.

At step 439, the computing device may calculate the new cost of insurance of the new route the driver may be traveling. The computing device may determine the cost of insurance of the new route as previously described. In some aspects, the computing device may determine the cost of the previous route the driver has traveled (up until the point of deviation), and combine it with the cost of the new route the driver may travel to reach their destination. Once the new cost of insurance is determined, the new cost may be provided to the driver at step 441. For example, the computing device may transmit an email, alert, text message, voice message, notification, and the like to a device operated or controlled by the driver to provide the new cost to the driver. In some embodiments, the risk map may be used to calculate insurance cost. For example, the risk map may be used to track the route and number of miles a vehicle has traveled as well as the different roads and road conditions the vehicle has traveled while traveling those miles. This risk map may also be used to gather information about the amount of miles traveled and the road conditions of those miles to determine the cost of insurance. After step 441, the method may return to step 429 to update the risk map if necessary based on any changes to the environment and/or roadways.

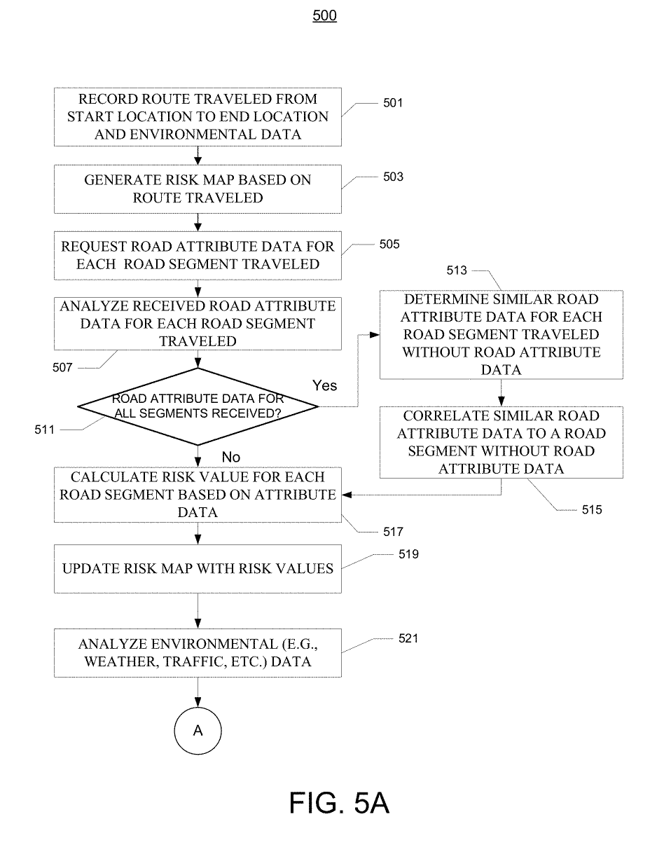

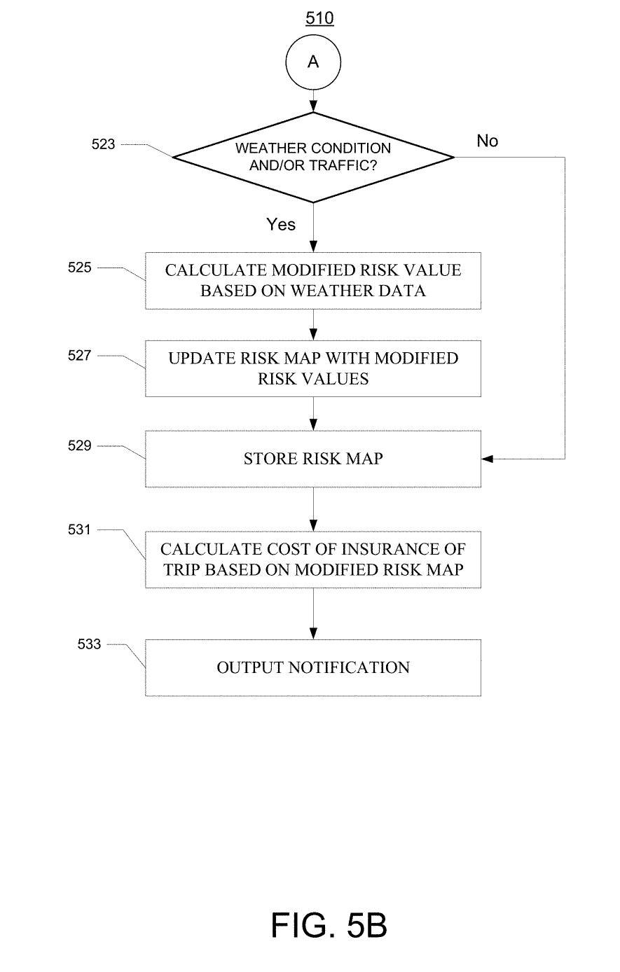

FIGS. 5A and 5B illustrate a method for generating a risk map and providing a user the cost of insurance based on the route of travel. The method may begin at step 501. At step 501, a computing device may record a route traveled by a vehicle from a start location to an end location, and may also record the weather data or other environmental data related to the route traveled. The computing device may communicate with a GPS device in order to obtain geographic information or the information (e.g., coordinates) relevant to tracking the vehicle to determine the route traveled. The weather data or other environmental data may be similar to the data/information previously described and may be obtained from other computing devices or servers. In some embodiments, the weather data or other environmental data may be obtained via one or more sensor attached to the vehicle. After step 501, the method may proceed to step 503.

At step 503, the computing device may generate a risk map based on the route traveled (e.g., determined at step 501). The risk map may be a risk map similar to any risk map previously described. The risk map may contain one or more road segments that make up the route, which was traveled by the vehicle. In some embodiments, step 503 may include breaking up the route recorded in step 501 into multiple road segments. Breaking up the route into various road segments may be performed based on road attribute information obtained from one or more databases (including third party databases, such as those created by parties that have taken on the arduous task of characterizing roads for a town, city, or other municipality.) In some instances, road segments may be created or devised by HERE, a map program (i.e., HERE Maps). For example, the road segments may be called Link_IDs. In some aspects, INRIX may supply volume data. Further, INRIX may use XD segments in order to create road segments. In some aspects, road segments may be created using a government standard/application called traffic message channel (TMC) After generating the risk map, the method may proceed to step 505. At step 505, the computing device may request information or data from another computing device and or server for attribute data for each road segment that may create the route that was traveled by the vehicle. In some aspects, the computing device may request attribute data for each road segment in the risk map from a database, device, or server. Resulting from the request, the computing device may receive the attribute data for each road segment traveled by the vehicle. The computing device may receive the attribute data from another device, one or more servers, and/or one or more databases. Upon completion of this step, the method may proceed to step 507.

At step 507, the computing device may analyze the received road attribute data for each road segment traveled by the vehicle. The computing device may analyze the road attribute data for risk scores that identify the amount of risk correlated to each road segment. After step 507, the method may proceed to step 511.

At step 511, the computing device may determine whether road attribute data was received for each road segment that makes up the route that was traveled. In some instances, road attribute data may not exist for a road segment, because the road segment may have not been traveled before, may be new, may not have any attribute data calculated for it, etc. If the computing device determines that not all road attribute data was received for all road segments, the method may proceed to step 513. If the computing device determines road attribute data for all road segments was received, the method may proceed to step 517.

At step 513, the computing device may analyze and compare a road segment that does not have attribute data to a road segment with similar characteristics that has attribute data. For example, if a road segment without attribute data is a 4 lane highway, the computing device may identify other road segments that are 4 lane highways that have road attribute data. In some aspects, the computing device may look for as many similar attributes of the road segment lacking attribute data to match it to a similar road segment with attribute data. The road attributes (e.g., road characteristics) may be any of the previously described road attributes or characteristics. Obtaining attribute data may be completed as previously described with reference to FIGS. 4A and 4B. Upon completion of step 513, the method may proceed to step 515.

At step 515, the computing device may correlate the road attribute data of the identified similar road segment with road attribute data to the road segment without any road attribute data. In some aspects, there may be multiple similar road segments with attribute data, in this case, the computing device may select the road segment with the best fit or most similar road attributes. In some cases, the computing device may combine and average the road attribute data of the plurality of identified similar road segments to create the missing road attribute data. After step 515, the method may proceed to step 517.

At step 517, the computing device may calculate a risk value or risk score for each road segment based on the attribute data. The risk value or risk score may be calculated as previously described. After step 517, the method may proceed to step 519.

At step 519, the computing device may update the risk map may be with the risk values and/or risk scores. In some aspects, depending on the risk value certain road segments may have an identifier or modifier to highlight a risk object or a certain level of risk as previously described. After step 519, the method may proceed to step 521.

At step 521, the computing device may analyze environmental data, such as the weather data and/or traffic data (traffic information) obtained at step 501. For example, the computing device may determine what the weather conditions and/or traffic conditions were as the vehicle traveled the recorded route, or if there were any weather conditions and/or traffic conditions while the vehicle traveled the recorded route. The weather data may be similar to any previously described weather data. For example, the computing device may determine if it was raining, snowing, icy, snow covered road, slick road, wet road, sleet on road, blinding sun, etc., or any other type of weather condition that may affect a driver or vehicle as they traveled on the recorded route. The traffic data may be similar to any previously described traffic data or traffic information. For example, the computing device may determine the number of vehicles on the road, the type of vehicles on the road, the type of traffic (slow, fast, bumper to bumper, moving, stop and start, etc.), amount of delay, flow of traffic, heavy traffic, medium traffic, light traffic, and the like. Upon completion of step 521, the method may proceed to step 523.

At step 523, the computing device may determine if there was an influential or significant weather condition and/or traffic condition that should be considered for purposes of determining the level of risk of the route traveled and/or the cost of insurance for the route traveled. The computing device may determine if the weather data and/or traffic data (or traffic information) will enhance the risk value or risk score above a threshold. The threshold may be a value set to categorize if the weather creates an unsafe driving condition or increases the likelihood of an accident occurring. In some embodiments, the computing device may determine that a weather condition and/or traffic condition was present if the weather condition and/or traffic condition creates a weather risk value and/or traffic risk value over a threshold. If the weather and/or traffic risk value exceeds the threshold, then it may be determined that a weather condition and/or traffic condition is present and worth taking into consideration. If a weather condition and/or traffic condition is present, the method may proceed to step 525. If a weather condition and/or traffic condition is not present, the method may proceed to step 529.

At step 525, the computing device may calculate a modified risk value and/or risk score for the road segments based on the weather condition. The modified risk value and/or risk score may be calculated as previously described. After step 525, the method may proceed to step 527.

At step 527, the computing device may update the risk map with the modified risk values or risk scores as previously described. Upon completion of step 527, the method may proceed to step 529.

At step 529, the computing device may store the risk map and all information related to the risk map as previously described. Next, the method may proceed to step 531.

At step 531, the computing device may calculate the cost of insurance of the route traveled based on the modified risk map. The computing device may analyze the risk values and/or risk scores to determine the amount or premium for insurance a driver should be charged for the route the driver has driven. In some aspects, the risk values and/or risk scores of the road segments or the route may correlate to a monetary value, and the monetary values of each road segment that make up the traveled route may be combined to determine the cost of insurance for a trip. After step 531, the method may proceed to step 533.

At step 533, the computing system may output an alert or notification to a user identifying the cost of insurance for the trip. This may be similar to any previously described method of outputting an alert, risk map, or notification to a user or driver.

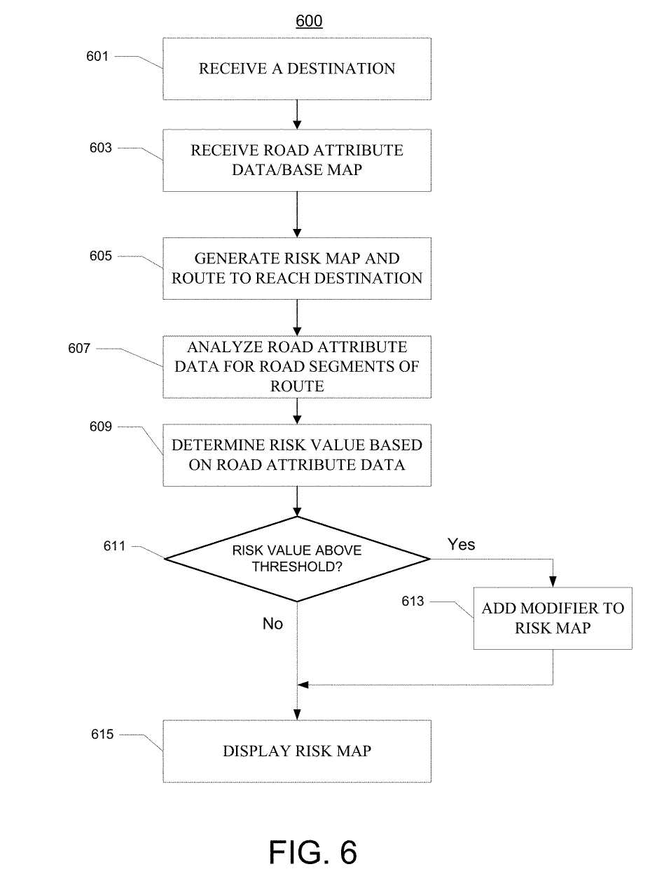

FIG. 6 illustrates a method for generating a risk map and providing an alert to a user. At step 601, a computing device may receive a destination from a driver of a vehicle. The computing device may determine a route of travel for the driver to follow to reach their desired destination. Upon completion of step 601, the method may continue to step 603.

At step 603, the computing device may receive road attribute data or base map data as previously described. After step 603, the method may move to step 605. At step 605, the computing device may generate a risk map or a route to reach the desired destination. The computing device may generate the risk map as previously described. Once step 605 has completed, the method may continue to step 607.

At step 607, the computing device may analyze the road attribute data as previously described. After step 607, the method may proceed to step 609. At step 609, the computing device may determine a risk value for the road segments and risk map as previously described. Upon completion of step 609, the method may proceed to step 611.

At step 611, the computing device may determine if the determined risk value is above a threshold. If the risk value is above a threshold, the method may proceed to step 613. If the risk value is below the threshold, the method may proceed to step 615. The threshold may be determined based on a user preference set by the user/driver or may be determined by an insurance provider (and different drivers may have different thresholds). The threshold may identify that a road segment contains (or is associated with) a risk object that may have a high probability of causing the vehicle the driver is driving to be in an accident.

At step 613, the computing device may add a modifier to a risk map which may identify a risk object. In some aspects, the computing device may add a modifier or an enhancement as previously described. After step 613, the method may proceed to step 615. At step 615, the computing device may display the risk map with the modifier as previously described.

In light of the present disclosure, it should be understood that steps may be added, omitted, or modified to the methods of the FIGS. 4A, 4B, 5A, 5B, and 6.

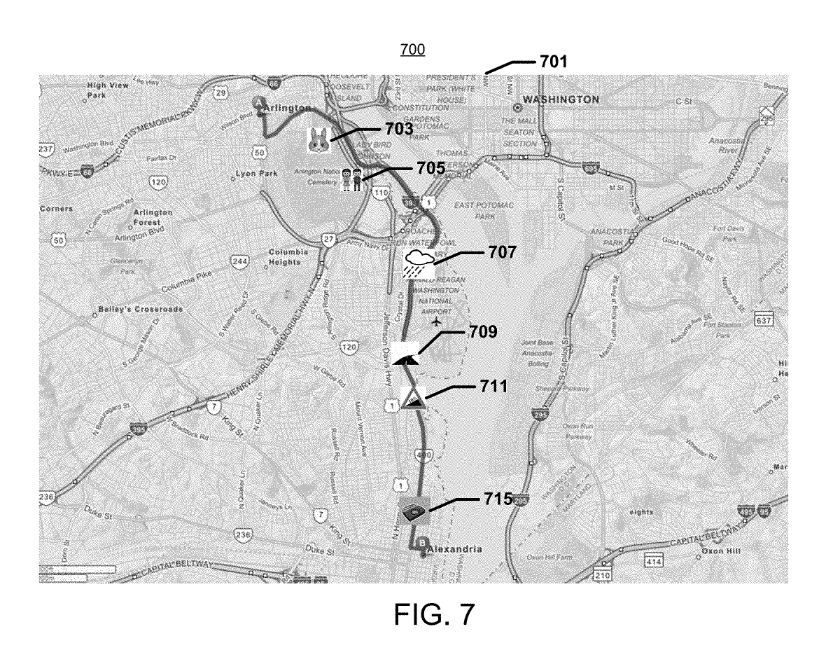

FIG. 7 illustrates an example risk map in accordance with the present disclosure. A user interface (e.g., monitor, touch-screen, etc.) 700 may display a risk map 701 to a user. As shown in FIG. 7, the risk map 701 may include modifiers, indicator, or enhancements identifying potential risk objects or risks to a vehicle traveling a particular route. For example, A and B on the risk map 701 may designate a start location and an end location of a trip a driver may want to take. The route highlighted between location designation points A and B may be made up of one or more road segments. The risk map 701 may also include risk objects or risks along the route or road segments identifying potential risks to a driver traveling the selected route (e.g., risk objects 703, 705, 707, 709, 711, and 715).

Risk object 703 may be an indicator used to represent the risk of an animal becoming a potential hazard to the vehicle as it travels. Risk object 705 may be an indicator used to represent the risk of pedestrians becoming a potential hazard to the vehicle as it travels. Risk object 707 may represent rain or precipitation over a road segment. This may allow the driver to prepare for slick, wet, or flooded road conditions along that road segment. Risk object 709 may identify the driver of a potential curve in the road, or a curve that may be a blind curve or dangerous curve where a lot of accidents are known or expected to occur. Risk object 711 may represent to the driver that there is a 10% incline in the road segment. In some cases, this may identify that the road segment is abnormally steep and may be important information for a driver who may be operating a vehicle with bad or worn brakes. Risk object 715 may represent to the driver that the road segment has a pothole, which may cause damage to the vehicle if not avoided. Risk map 701 is one of many different possibilities of what a risk map may be displayed as. It should be understood that the risk map 701 may vary depending on the many different drivers, different routes, and/or different conditions. Moreover, because drivers, routes, and conditions may change, the risk map 701 may be dynamically updated. For example, if it stops raining before the driver reaches the road segment where a risk object 707 is located, then the risk object 707 may be removed. Alternatively, if the rain moves to a different area or another area of rain may affect the route, the risk object 707 may move to that different area on the risk map 701 or an additional risk object identical to or similar to (e.g., perhaps smaller if there is less rain) the risk object 707 may be added to the risk map 701. In some cases, where rain or another potential risk object moves and the risk map 701 includes a video file (e.g., MPEG file), the risk map 701 may show the corresponding risk object moving. For example, the risk map 701 may be animated to illustrate the risk object 707 moving over the risk map 701. Due to the dynamic nature of risk maps, it should be understood that there are an infinite number of risk maps and thus not all versions of the risk map 701 can be illustrated.

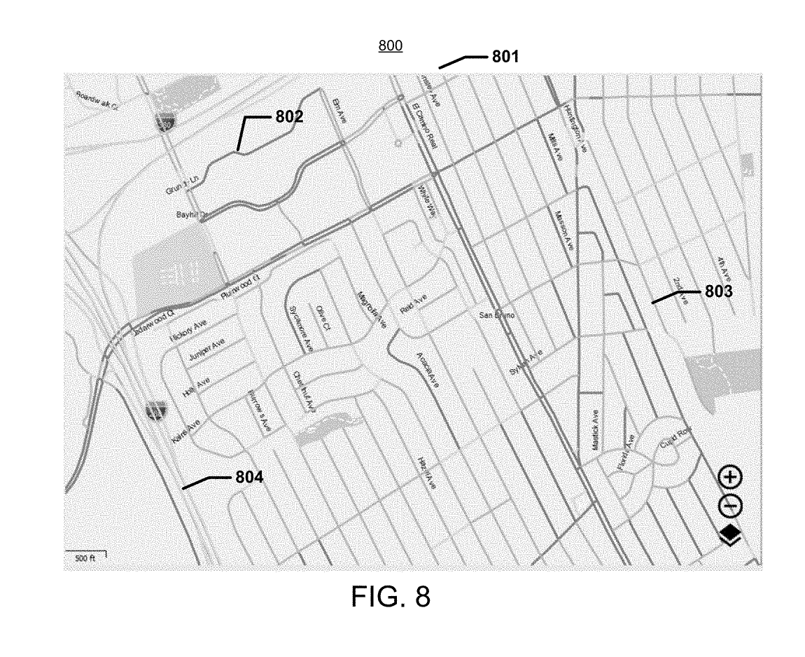

In some embodiments, the risk map may receive data from a vehicle to understand the severity of an accident and may be adjusted accordingly. For example, the risk map may indicate a high velocity accident so that a specialized emergency response team shows up to an accident site. In some examples, the risk map may include social components. For example, a social component to the risk map may indicate in real time when a new risk has occurred. As another example, the risk map may incorporate government data to indicate new problems and re-route the driver or user accordingly. In some instances, the risk map may be able to detect driver behavior (e.g., drowsy, angry, drunk, excitable, dangerous, erratic, and the like), adjust risk, and provide alerts accordingly. In some embodiments, the risk map may identify risk of certain autonomous cars (by maker) and alert that maker and those owners to software bugs FIG. 8 illustrates an example risk map in accordance with the present disclosure. A user interface (e.g., monitor, touch-screen, etc.) 800 may display a risk map 801 to a user. As shown in FIG. 8, the risk map 801 may include modifiers, indicators, or enhancements identifying potential risk objects or risks to a vehicle traveling a particular route. In some embodiments, the map may have an indicator, modifier, or enhancement for identifying traffic conditions on the routes and roads located near or around a vehicle as it travels to a destination. Road segment or route segment 802 may have an identifier (e.g., red color highlighting) marking it as a roadway that may contain high (or heavy) congestion (or traffic rate) or another high risk object (e.g., animal on the road, many pedestrians, flooding, etc.). The road speed on road segment 802 may be below a certain predetermined threshold (which may be specific to the specific road (e.g., main street) or specific to the type of road (e.g., residential road or highway)). The threshold may be set to a certain miles per hour for an average speed of a vehicle traveling along that particular road segment. Road segment or route segment 803 may have a different identifier (e.g., orange or yellow color highlighting) marking it as a roadway containing medium (or moderate) congestion (or traffic rate) or another medium risk object (e.g., animal on side of road, medium or average amount of pedestrians, minor flooding, etc.). In some aspects, the road speed on road segment 803 may be between two predetermined thresholds. Road segment or route segment 804 may have yet another identifier (e.g., green color highlighting) marking it as a roadway containing low or no congestion (or low or no traffic) or containing no risk objects or low risk objects (e.g., few pedestrians, no flooding, etc.). In some aspects, the road speed on road segment 804 may be above a predetermined threshold.

It should be understood that FIG. 8 shows an example view of the risk map 801, and that the user may select a desired view from a plurality of different views. The user may also choose which risks are identified or depicted on the risk map 801. In the example shown in FIG. 8, the user has chosen to view traffic risks. In other embodiments, risk map 801 may have additional identifiers highlighting other risks and/or risk objects that may affect the user.

The foregoing descriptions of the disclosure have been presented for purposes of illustration and description. They are not exhaustive and do not limit the disclosure to the precise form disclosed. Modifications and variations are possible in light of the above teachings or may be acquired from practicing of the disclosure. For example, where the described implementation includes software, it should be understood that a combination of hardware and software or hardware alone may be used in various other embodiments. Additionally, although aspects of the present disclosure are described as being stored in memory, one skilled in the art will appreciate that these aspects can also be stored on other types of computer-readable media (including transitory/non-transitory computer-readable media), such as secondary storage devices, like hard disks, floppy disks, or CD-ROM; a carrier wave from the Internet or other propagation medium; or other forms of RAM or ROM.

What is claimed is:

1. A system comprising:
a first computing device configured to:
communicate with one or more devices to receive base map information, wherein the base map information comprises a plurality of attribute information associated with a plurality of road segments;
receive trip request information from a user device operated by a user;
determine a route for the user to travel based on the trip request information and the base map information;
calculate a risk score for each road segment of the plurality of road segments forming the route;
generate a risk map based on the risk score and the route; and
output, on a display, the risk map to the user.

2. The system of claim 1, wherein the base map information comprises volume data and accident data, wherein the volume data comprises information about a number of vehicles traveling over a particular road segment of the plurality of road segments, and the accident data comprises information about a number of accidents on the particular road segment.

3. The system of claim 1, further comprising:
one or more sensors, coupled to a vehicle, configured to:
detect sensor information; and
detect weather data.

4. The system of claim 3, wherein the first computing device is further configured to:
calculate a new risk score for a particular road segment of the plurality of road segments using the sensor information and weather data; and
generate a modified risk map based on the new risk score and the route.

5. The system of claim 1, wherein the first computing device is further configured to:
calculate, based on the risk score for each road segment forming the route, a route risk score; and
determine an insurance premium for traveling the route based on the route risk score.

6. The system of claim 5, wherein the first computing device is further configured to:
determine whether the route risk score exceeds a threshold;
in response to determining that the route risk score exceeds the threshold, calculate a new route; and
update the risk map to depict the new route.

7. The system of claim 1, wherein the first computing device is further configured to:
determine whether the risk score for each road segment forming the route exceeds a threshold;
identify a particular road segment as an alert road segment if the risk score for the particular road segment exceeds the threshold;
update the risk map with an indicator identifying the alert road segment; and
output, on the display, the updated risk map to the user.

8. A method comprising:
receiving, by a computing device from one or more devices, base map information, wherein the base map information comprises a plurality of attribute information associated with a plurality of road segments;
receiving, by the computing device, trip request information from a user device operated by a user;
determining, by the computing device, a route for the user to travel based on the trip request information and the base map information;
calculating, by the computing device, a risk score for each road segment of the plurality of road segments forming the route;
generating, by the computing device, a risk map based on the risk score and the route; and
outputting, on a display, the risk map to the user.

9. The method of claim 8, wherein the base map information comprises volume data and accident data, wherein the volume data comprises information about a number of vehicles traveling over a particular road segment of the plurality of road segments, and the accident data comprises information about a number of accidents on the particular road segment.

10. The method of claim 8, further comprising, detecting, by one or more sensors coupled to a vehicle, sensor information.

11. The method of claim 10, further comprising:
calculating, by the computing device, a new risk score for a particular road segment of the plurality of road segments using the sensor information; and
generating, by the computing device, a modified risk map based on the new risk score and the route.

12. The method of claim 8, further comprising:
calculating, by the computing device, based on the risk score for each road segment forming the route, a route risk score; and
determining, by the computing device, an insurance premium for traveling the route based on the route risk score.

13. The method of claim 12, further comprising:
determining, by the computing device, whether the route risk score exceeds a threshold;
in response to determining the route risk score exceeds the threshold, calculating, by the computing device, a new route; and
updating, by the computing device, the risk map to depict the new route.

14. The method of claim 8, further comprising:
determining, by the computing device, whether the risk score exceeds a threshold;
identifying, by the computing device, a particular road segment as an alert road segment if the risk score for the particular road segment exceeds the threshold;
updating, by the computing device, the risk map with an indicator identifying the alert road segments; and
outputting, on the display, the updated risk map to the user.

15. A non-transitory computer-readable storage medium storing computer-executable instructions that, when executed by a computing device, cause the computing device to:
communicate with one or more devices to receive base map information, wherein the base map information comprises a plurality of attribute information associated with a plurality of road segments;
receive trip request information from a user device operated by a user;
determine a route for the user to travel based on the trip request information and the base map information;
calculate a risk score for each road segment of the plurality of road segments forming the route;
generate a risk map based on the risk score and the route; and
output, on a display, the risk map to the user.

16. The non-transitory computer-readable storage medium of claim 15, wherein the base map information comprises volume data and accident data, wherein the volume data comprises information about a number of vehicles traveling over a particular road segment of the plurality of road segments, and the accident data comprises information about a number of accidents on the particular road segment.

17. The non-transitory computer-readable storage medium of claim 15, wherein the computer-executable instructions, when executed, further cause the computing device to:
calculate, based on the risk score for each road segment forming the route, a route risk score; and
determine an insurance premium for traveling the route based on the route risk score.

18. The non-transitory computer-readable storage medium of claim 17, wherein the computer-executable instructions, when executed, further cause the computing device to:
determine whether the route risk score exceeds a threshold;
in response to determining that the route risk score exceeds the threshold, calculate a new route; and
update the risk map to depict the new route.

19. The non-transitory computer-readable storage medium of claim 15, wherein the computer-executable instructions, when executed, further cause the computing device to:
determine whether the risk score for each road segment forming the route exceeds a threshold;
identify a particular road segment as an alert road segment if the risk score for the particular road segment exceeds the threshold;
update the risk map with an indicator identifying the alert road segment; and
output, on the display, the updated risk map to the user.

20. The non-transitory computer-readable storage medium of claim 15, wherein the computer-executable instructions, when executed, further cause the computing device to:
obtain, from a sensor coupled to a vehicle, sensor information; and
dynamically update the risk map based on the sensor information to add, remove, or move a risk object overlaying the risk map.
